(19) United States
(12) Patent Application Publication
(10) Pub. No.: US 2009/0065725 A1
(43) Pub. Date: Mar. 12, 2009

(54) GAS DOSING VALVE

(75) Inventor: BRUNO LENHERR, Gams (CH)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: VAT Holding AG

(21) Appl. No.: 12/207,848

(22) Filed: Sep. 10, 2008

(30) Foreign Application Priority Data
Sep. 10, 2007 (DE) 10 2007 042 854.7

(51) Int. Cl. F16K 31/44

(52) U.S. Cl. 251/242

(57) ABSTRACT

A gas metering valve has a valve seat and a closure member which can be pressed against the valve seat in a closed position, and a tiltable lever for pressing the closure member against the valve seat. A transmission plate is arranged between the closure member and the lever in such a way that the lever, or a transmission element arranged at the lever, slides along the transmission plate during a tilting movement of the lever so that the closure member is movable from an open position into its closed position.

The present application claims priority from German Patent Application No. 10 2007 042 854.7 filed on Sep. 10, 2007, the disclosure of which is incorporated herein by reference in its entirety.

### BACKGROUND OF THE INVENTION

1. Field of the Invention

The present invention is directed to a gas metering valve with a valve seat and a closure member which can be pressed against the valve seat in a closed position, and a tiltable lever for pressing the closure member against the valve seat.

2. Description of the Related Art

Gas metering valves of the generic type are used primarily in vacuum engineering, where technically demanding production processes run in an artificially realized, extensively gas-free space. The generic gas metering valves are needed, for example, to continuously supply an accurately metered quantity of a gaseous reactant during the vacuum process or to maintain the pressure in the vacuum space at a predetermined level. Based on these requirements, these gas metering valves must still close reliably and in a durably metallically sealing manner in the range of very high vacuum pressures on the one hand and, on the other hand, must also make it possible to precisely meter gases under these conditions. This results in very high requirements with respect to precision in the manufacture of the gas metering valves.

It is known from the prior art, e.g., U.S. Pat. No. 4,903,938, to use linearly displaceable actuators for moving the closure member between the closed position and the open position. This technique is disadvantageous on the one hand in that it is very sensitive to temperature because of material expansion and, on the other hand, it must be constructed with the utmost precision.

In order to improve this situation, it is known, e.g., from CH 600 224, to use gas metering valves of the generic type with a tiltable lever for pressing the closure member against the valve seat. This has the advantage that large forces can be realized along with very accurately adjustable lifts at the same time by means of the tiltable lever and corresponding leverage. However, tiltable levers are problematic in that, apart from the desired movement component orthogonal to the valve seat, they also generate a movement component or force component in perpendicular direction relative to the desired movement direction of the closure member that must be compensated and should not act on the closure member. For this purpose, in CH 600 224, a push rod which is supported on pointed ends on both sides is provided between the tiltable lever and the closure member and ensures that only a force with the desired directional component is transmitted to the closure member. Further, it is known from prior public use to provide balls instead of points at the ends of the push rod in a construction that is fundamentally the same in other respects. A valve of this kind is sold, e.g., by Pfeifer Vacuum GmbH under the trade name UDV 040.

In spite of an improvement over the prior art cited above, the previously known generic gas metering valves with a tiltable lever have the disadvantage that they must be manufactured with very high precision and, as a result of wear and tear on the push rod or other valve parts over the course of time, individual structural component parts can jam, which cannot always be solved by readjustment.

### SUMMARY OF THE INVENTION

Therefore, it is the object of the present invention to improve gas metering valves of the generic type in such a way that very precise lifts of the closure member with sufficiently large forces are also possible over the long term.

According to the invention, this object is met in a gas metering valve of the generic type in that a transmission plate is arranged between the closure member and the lever in such a way that the lever, or a transmission element arranged at the lever, slides along the transmission plate during a tilting movement of the lever so that the closure member is movable from an open position into its closed position.

Through use of the tiltable lever, it is possible when adjusting the corresponding leverages to provide a relatively long path when the lever is actuated by hand or by means of an actuator and to convert this into a relatively short path on the transmission plate side. This has two advantages. First, it provides large forces on the transmission plate side and, second, the path traveled on the transmission plate, and therefore also the closing lift of the closure member, can be adjusted in a very exact manner. Because of the movement of the lever, and of the transmission element arranged at the lever, along the transmission plate, reserve movement can be made available in a very simple manner without needing to take into consideration fixed stops and limits. In this way, changes in the length of individual structural component parts due to temperature fluctuations or wear can be compensated in a simple manner by a correspondingly larger or smaller path when actuating the lever without any negative impact on the precision of the gas metering. Further, the sliding of the lever or its transmission element along the transmission plate ensures that individual structural component parts will not jam as a result of wear even after a longer period of use of the gas metering valve. In all, the invention provides for a very robust gas metering valve that is comparatively simple to produce but is reliable and precise. This gas metering valve can be used for the high vacuum range or ultrahigh vacuum range. The high vacuum range pertains to gas pressures of less than 10⁻³ mbar (millibar). The ultrahigh vacuum range pertains to gas pressures of less than 10⁻⁸ mbar for which the gas metering valve according to the invention can also be designed. As in the metering rates indicated in the following, these values relate in particular to helium. With regard to the metering rates, the gas metering valve according to the invention can be designed in such a way that it is suitable for metering rates of less than 10⁻³ mbarl/s (millibar liters per second). It is even possible to design the gas metering valve for metering rates of less than 1-8 mbarl/s.

The gas metering valve is preferably constructed as an all-metal valve so that it can be heated for cleaning purposes. By this is meant a valve in which at least all of the structural component parts coming into contact with the gas to be metered are made of metal. It is advantageous when all of the structural component parts of the gas metering valve are made of metal. Apart from metal, ceramic structural component parts can also be used in a gas metering valve of this kind, e.g., for the valve seat. Preferred metals, particularly for the valve seat and/or closure members, include nickel alloys or stainless steels. Suitable nickel alloys are sold under the trade names Inconel or Nimonic, for example.

Further details and advantages of the invention will be described in the following description of the drawings with reference to two preferred embodiment examples.

### BRIEF DESCRIPTION OF THE DRAWINGS

FIGS. 1 and 2 show the first embodiment example according to the invention in the open position;

FIGS. 3 and 4 show the first embodiment example in the closed position;

FIG. 5 shows the first embodiment example from the outside; and

FIG. 6 shows an alternative construction of a second embodiment example according to the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

In both embodiment examples, the gas metering valve has two housing parts 15 and 16 which are connected with one another, particularly screwed together. The gas inlet channel 20 and the gas outlet channel 19 are provided in the bottom housing part 16. Gas lines can be screwed on or fastened in some other way by corresponding flanges 18. The valve seat 1 is also provided in the bottom housing part 16. The closure member 2, which is constructed in the form of a diaphragm in this instance, is clamped between the top housing part 15 and the bottom housing part 16. This will be described in more detail in the following.

The tiltable lever 3 is mounted in the top housing part 15 so as to be tiltable around a tilting axis 6 in the upper housing. This tilting axis 6 is arranged eccentrically at the tilting lever 3 in the embodiment example shown herein. This eccentricity is achieved in that the tilting axis 6 acts on the lever 3 laterally adjacent to the longitudinal axis 22. The lever 3 is actuated at its upper end by an actuator 14. As is shown here, this actuator 14 can be a knob which can be screwed in and unscrewed by hand. However, all other actuators known per se from the prior art which operate hydraulically, pneumatically, electrically or in some other way can also be used to actuate the lever 3. The lever 3 contacts the transmission plate 4 on the side opposite from the tilting axis 6, in this case by means of the transmission element 5 which is shaped as a ball. It should be noted that a transmission element 5 need not necessarily be provided; rather, the lever 3 itself can also slide directly along the transmission plate 4. At all events, it is advantageous when the lever 3 or the transmission element 5 has a rounded surface with which it can slide along the transmission plate 4. Of course, a rotatably supported roller or other sliding element could also be provided as transmission element 5 instead of the ball.

In the embodiment example shown herein, the ratio of the distance 27 of the point of contact of the transmission element 5 on the transmission plate 4 from the tilting axis 6 on the one side to the distance 28 of the tilting axis 6 from the point at which the actuator 14 acts at the lever 3 on the other side is about 12 to 83. This leverage results in a corresponding stepping down of the path and a stepping up of the forces ultimately introduced from the transmission element 5 to the transmission plate 4. To this end, it is advantageous to provide a ratio of the aforementioned distances 27 and 28 of at least 1 to 5.

In advantageous embodiment forms of the invention, maximum angular ranges of 45°, preferably a maximum angular range of 30°, are enclosed between a connecting line drawn between the tilting axis 6 and the point of contact of the transmission element 5 on the transmission plate 4 and the movement direction of the closure member 2 (parallel to the longitudinal axis 25 in this instance) in the tilting movement of the lever 3.

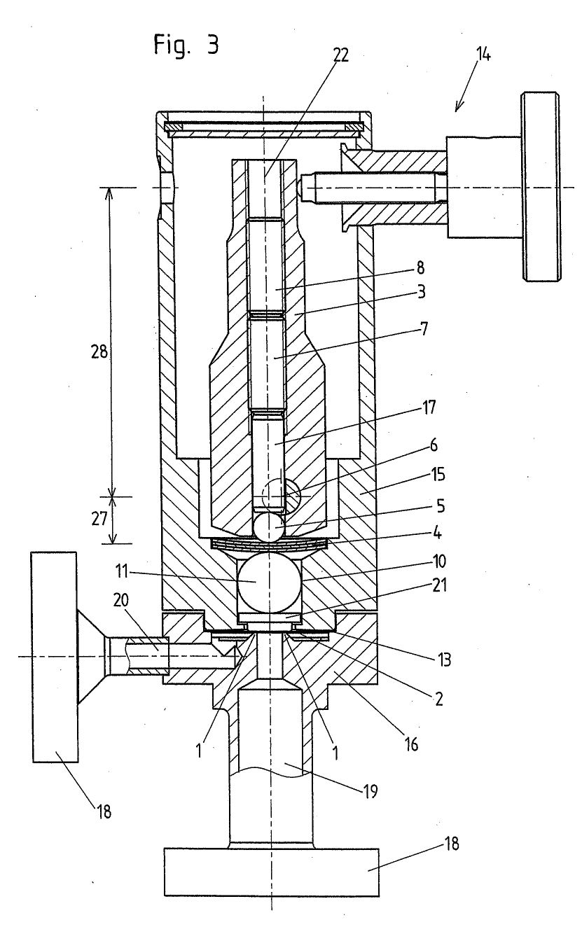

In principle, it is advantageous when the lever 3 or the transmission element 5 always remains on one side of a dead center when sliding along the transmission plate. In the embodiment example shown herein, this is achieved when the longitudinal axis 22 of the lever 3 is never moved over the longitudinal axis 25 of the housing 15 but, on the contrary, is still at a distance from, or at most reaches, the dead center (FIG. 3) even in the closed position. It must be considered in this connection that the dead center is the point of maximum excursion of the transmission plate 4 and, therefore, a movement of the lever 3 over the dead center would result in a relieving of the transmission plate 4. Therefore, it is advantageous when the closed position of the closure member 2 is already reached before the lever 3 or the transmission element 5 reaches its dead center so that a reserve movement can still be preserved. By means of this reserve movement, it is possible to respond to thermal or wear-related changes in the length of individual structural component parts so that the valve can still be fully closed in such a case in that the lever 3 tilts somewhat farther and the existing reserve is used up.

In order to adjust this in a corresponding manner, an adjusting device 7 is provided in the present embodiment example in the form of a headless screw by which the distance 27 between the point of contact of the transmission element 5 on the transmission plate 4 and the tilting axis 6 is configured in an adjustable manner by means of the intermediate pin 17. A locking screw 8, also constructed as a headless screw, is provided in the lever 3 in addition in order to fix the distance once it has been adjusted.

The transmission plate 4 can move toward the valve seat 1, preferably in opposition to an elastic spring loading, when the lever 3 or transmission element 5 slides along. Accordingly, this spring loading acts in the direction of the lever 3 and therefore in direction of the open position of the valve. In the embodiment example shown herein, this spring loading is realized in that the transmission plate 4 itself is constructed so as to be elastically deformable. This can be achieved, for example, in that the transmission plate 4 has a leaf spring or a spring set comprising a plurality of leaf springs as is shown in the present embodiment example. In the present embodiment example, the transmission plate 4 is supported at its edges by the shoulders 26 provided in the top housing part 15. It can only be moved in the area between the supported edges—in this case in its middle area—in the direction of the valve seat 1.

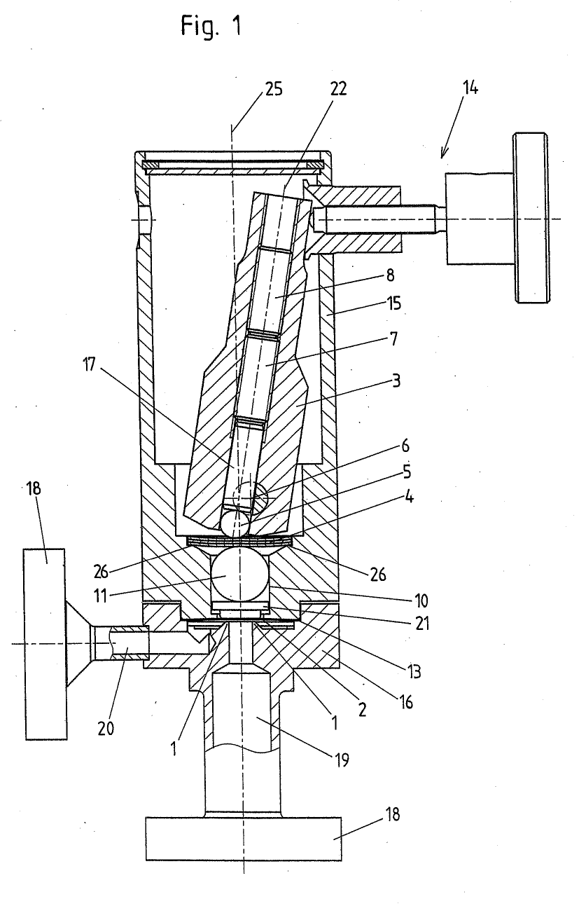

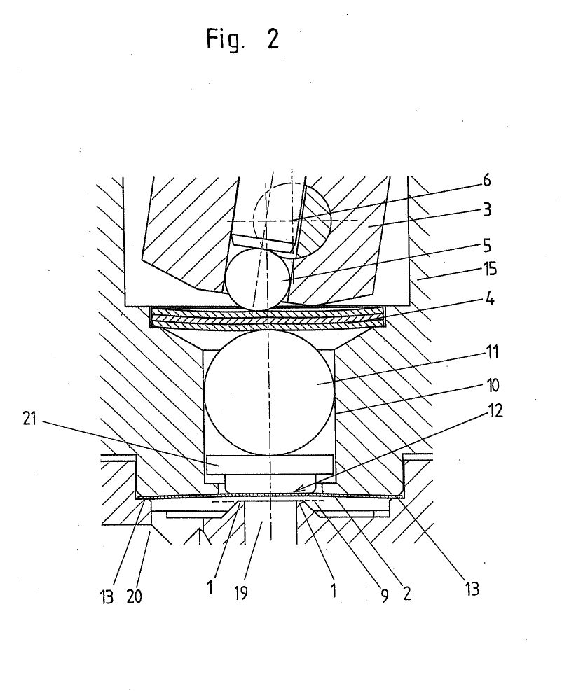

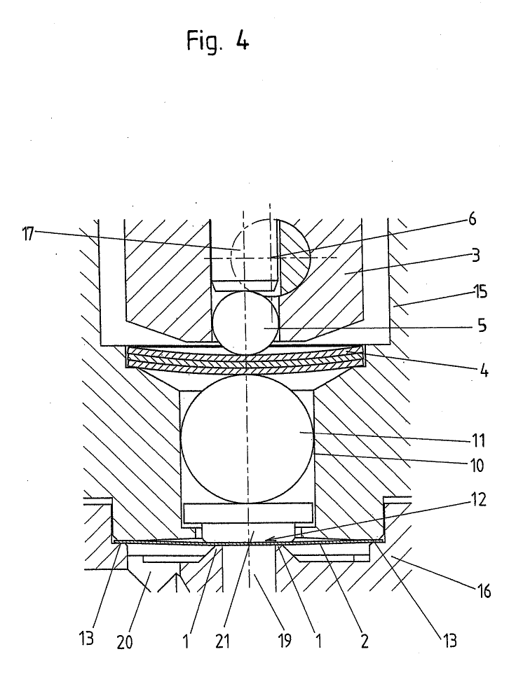

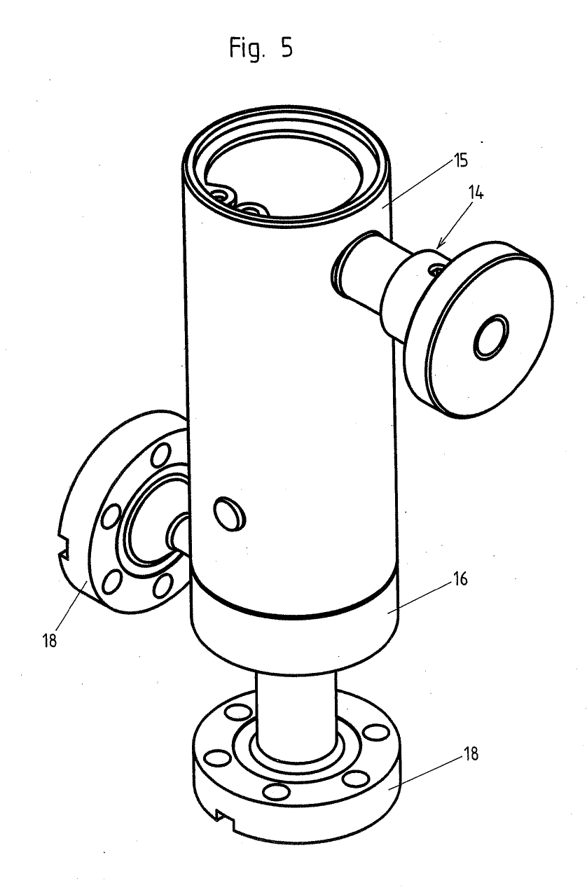

Due to the fact that the transmission element 5 or the lever 3 slides along the transmission plate 4, substantially only a force component acting orthogonal to the plane 9 defined by the valve seat 1 is transmitted in direction of the valve seat 1. However, since it is important particularly when used under vacuum or high vacuum that the closure member 2 closes in an extremely exact manner, a compensating device can be provided additionally, as in the present embodiment example, between the transmission plate 4 and the closure member 2, which compensating device compensates a parallel force component parallel to the plane 9 in such a way that it is not transmitted to the closure member 2. In the first embodiment example according to FIGS. 1 to 5, this compensating device has a ball 11 which is positively guided in a channel 10 and contacts the transmission plate 4 on the side of the latter opposite the lever 3. The ball 11 is moved in direction of the valve seat 1 from the open position shown in FIG. 1 into the closed position shown in FIG. 3 by the transmission plate 4 when the lever is tilted. Any force component parallel to the plane 9 which is still transmitted by the transmission plate 4 is conducted into the wall of the channel 10 by the ball 11 and is therefore eliminated. The ball 11 transmits to the intermediate plate 21 exclusively an orthogonal force component acting orthogonal to the plane 9 defined by the valve seat 1. As can be seen particularly in the detailed views according to FIGS. 2 and 4, the compensating device—in the form of the intermediate plate 21 in this instance—has, in the direction toward the closure member 2, a flat outer surface 12 by which it contacts the closure member. This outer surface 12 should be larger than the surface defined by the valve seat 1 in plane 9 so that the closure member 2 is pressed on the valve seat over the greatest possible surface. The sealing that can be achieved between the closure member 2 and the valve seat 1 only results when the closure member is pressed on the valve seat in a corresponding manner and can therefore be called a dynamic seal.

As was already mentioned, the closure member 2 is constructed as a metal diaphragm in the embodiment examples shown herein. It is advantageous when the closure member 2 is spring-loaded in direction of the open position (FIGS. 1 and 2). In the first embodiment example according to FIGS. 1 to 5, this is achieved in that the diaphragm itself is elastically pretensioned in the direction of the open position. Further, the diaphragm in this embodiment example is clamped along the edges between the top housing part 15 and the bottom housing part 16, and the clamping 13 of the diaphragm along the edges simultaneously forms a gas-tight seal between the bottom housing part 16 and the top housing part 15. This ensures that no gas entering through the inlet channel 20 into the gas metering valve can reach the side of the closure member 2 remote of the valve seat 1. This seal is permanent and therefore can also be referred to as a static seal.

The sealing surfaces of the static and/or dynamic seal, that is, particularly the corresponding regions of the closure member 2 or diaphragm, the housing parts 15 and 16, and the valve seat 1, can be coated, preferably silvered-plated or gold-plated, individually or by pairs.

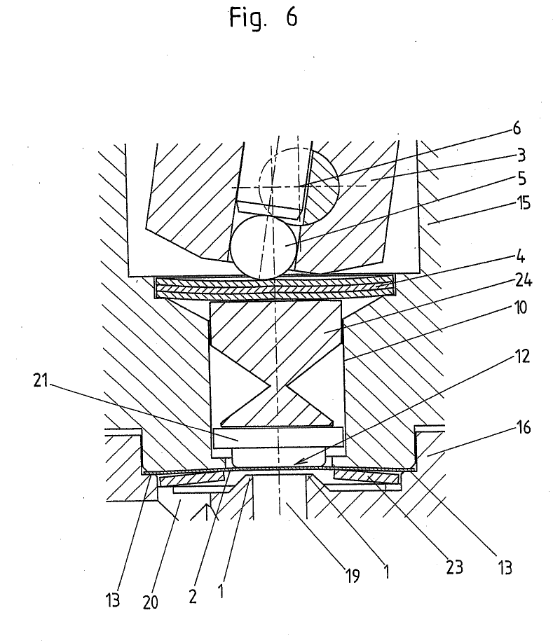

FIG. 6 shows a detailed view of an alternative embodiment in a second embodiment example analogous to FIG. 2 showing only the differences in relation to the first embodiment example. The rest of the gas metering valve according to the second embodiment example corresponds to the above statements referring to the first embodiment example.

In contrast to the first embodiment example, the spring loading of the valve seat 2 in the second embodiment example according to FIG. 6 is not realized by a corresponding pretensioning of the diaphragm, but rather by an additional spring ring 23. This spring ring 23 pretensions the closure member 2 in direction of the open position shown in FIG. 6.

Another difference compared to the first embodiment example consists in the construction of the compensating device arranged between the transmission plate 4 and the closure member 2 for compensating a force component acting parallel to the plane 9. In the embodiment example according to FIG. 6, a bending joint 4 is provided for this purpose, which ensures that exclusively a force component directed orthogonal to the plane 9 defined by the valve seat 1 is transmitted to the closure member 2. Naturally, any other correspondingly constructed joint can be used instead of the bending joint.

In conclusion, it is noted that the seal between the top housing part 15 and the bottom housing part 16, and, therefore, the static seal, need not necessarily be realized by a lateral clamping of a closure member 2 which is constructed as a diaphragm. It is also possible to provide corresponding seals detached from the closure member 2 between the top housing part 15 and bottom housing part 16. The closure member 2 can then be sealed relative to the top housing part, e.g., separately by a corresponding longitudinally movable bellows, and constructed as a rigid plate. The spring loading can then be implemented by means of springs which are supported in a corresponding manner at the top housing part 15 or bottom housing part 16.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

1 valve seat
2 closure member
3 lever
4 transmission plate
5 transmission element
6 tilting axis
7 adjusting device
8 locking screw
9 plane
10 channel
11 ball
12 flat outer surface
13 lateral clamping
14 actuator
15 top housing part
16 bottom housing part
17 intermediate pin
18 connection flange
19 outlet channel
20 inlet channel
21 intermediate plate
22 longitudinal axis
23 additional spring ring
24 bending joint
25 longitudinal axis
26 shoulder
27 distance
28 distance

1. A gas metering valve comprising:
a valve seat;
a closure member which can be pressed against the valve seat in a closed position,
a tiltable lever for pressing the closure member against the valve seat,
wherein a transmission plate is arranged between the closure member and the lever in such a way that the lever, or a transmission element arranged at the lever, slides along the transmission plate during a tilting movement of the lever so that the closure member is movable from an open position into its closed position.

2. The gas metering valve according to claim 1;
wherein the transmission plate can move toward the valve seat in opposition to an elastic spring loading when the lever or transmission element slides along the transmission plate.

3. The gas metering valve according to claim 2;
wherein the transmission plate is elastically deformable to provide the elastic spring loading.

4. The gas metering valve according to claim 3;
wherein the transmission plate is supported at least partially at its edges in such a way that it can only be moved in an area outside the supported edges in the direction of the valve seat.

5. The gas metering valve according to claim 3;
wherein the transmission plate is supported at least partially at its edges in such a way that it can only be moved in a middle area in the direction of the valve seat.

6. The gas metering valve according to claim 1;
wherein the transmission plate has a leaf spring or set of leaf springs comprising a plurality of leaf springs.

7. The gas metering valve according to claim 1;
wherein the lever or the transmission element has a rounded surface with which the lever or the transmission element can slide along the transmission plate.

8. The gas metering valve according to claim 1;
wherein at least one ball or at least one roller is provided as transmission element.

9. The gas metering valve according to claim 8;
wherein the ball or the roller is rotatably mounted.

10. The gas metering valve according to claim 1;
wherein the lever is arranged in such a way that it always remains on one side of a dead center when sliding along the transmission plate during the movement of the closure member from a maximum possible open position into the closed position.

11. The gas metering valve according to claim 10;
wherein the lever is arranged in such a way that it is at a distance from the dead center even in the closed position.

12. The gas metering valve according to claim 1;
wherein the lever is supported so as to be tiltable around a tilting axis.

13. The gas metering valve according to claim 12;
wherein the tilting axis is arranged eccentrically in that the tilting axis acts on the lever laterally adjacent to the longitudinal axis.

14. The gas metering valve according to claim 12;
wherein an adjusting device is provided for adjusting the distance between the tilting axis and the support point of the lever or of the transmission element on the transmission plate.

15. The gas metering valve according to claim 1;
wherein a compensating device is provided between the transmission plate and the closure member, which compensating device transmits an orthogonal force component in orthogonal direction relative to a plane defined by the valve seat and compensates a parallel force component parallel to this plane in such a way that it cannot be transmitted to the closure member.

16. The gas metering valve according to claim 15;
wherein the compensating device has a ball which is positively guided in a channel.

17. The gas metering valve according to claim 15;
wherein the compensating device has a flat outer surface by which it contacts the closure member.

18. The gas metering valve according to claim 1;
wherein the closure member is spring-loaded in direction of the open position.

19. The gas metering valve according to claim 1;
wherein the closure member is constructed as an elastically deformable diaphragm which can be clamped along the edges.

20. The gas metering valve according to claim 19;
wherein the clamping of the diaphragm along the edges forms a gas-tight seal between the two housing parts.

21. The gas metering valve according to claim 1;
wherein at least all of the structural component parts coming into contact with the gas to be metered or all of the structural component parts of the gas metering valve are made of a nickel alloy or stainless steel or another metal or ceramic.

22. The gas metering valve according to claim 1;
which is designed for gas metering in a gas pressure range of less than 10⁻³ mbar or less than 10⁻⁸ mbar.

23. The gas metering valve according to claim 1;
which is designed for gas metering at metering rates of less than 10⁻⁸ mbarl/s or less than 10⁻⁸ mbarl/s.
